(19) United States
(12) Patent Application Publication
(10) Pub. No.: US 2016/0371567 A1
(43) Pub. Date: Dec. 22, 2016

(54) IMAGE PROCESSING APPARATUS, IMAGE PICKUP APPARATUS, IMAGE PROCESSING METHOD, AND NON-TRANSITORY COMPUTER-READABLE STORAGE MEDIUM FOR ESTIMATING BLUR

(71) Applicant: CANON KABUSHIKI KAISHA, Tokyo (JP)

(72) Inventor: Norihito Hiasa, Utsunomiya-shi (JP)

(21) Appl. No.: 15/177,494

(22) Filed: Jun. 9, 2016

(30) Foreign Application Priority Data
Jun. 17, 2015 (JP) 2015-121680

(51) Int. Cl. G06K 9/62; G06T 11/60; G06K 9/52; G06T 3/40; G06T 5/00; G06K 9/46

(52) U.S. Cl. CPC G06K 9/6267; G06T 5/00; G06K 9/4661; G06K 9/52; G06T 3/40; G06T 11/60; G06T 2207/30168; G06T 2207/20221

(57) ABSTRACT

An image processing apparatus includes a determiner which determines a characteristic of a blur to be estimated based on a blurred image, and a generator which acquires a blur estimation area of at least a part of the blurred image to generate an estimated blur based on the blur estimation area, and the generator repeats blur estimation processing and correction processing on information relating to a signal in the blur estimation area using the blur to generate the estimated blur, and changes, depending on the characteristic of the blur, at least one of acquisition processing of the blur estimation area or the blur estimation processing, or a parameter to be used for the acquisition processing or the blur estimation processing.

### BACKGROUND OF THE INVENTION

Field of the Invention

The present invention relates to an image processing method of estimating a blur as a deterioration component acting on a blurred image based on a single blurred image.

Description of the Related Art

Recently, according to the enhancement of high definition of a display apparatus, the improvement of the image quality of a captured image is required. Due to a deterioration factor such as an aberration or a diffraction of an optical system used for photography or a hand shake during the photography, the captured image loses information of an object space. Accordingly, a method of correcting the deterioration of the captured image based on these factors to obtain a high-quality image is previously proposed. As such a method, for example, there is a method of using Wiener filter or Richardson-Lucy method. However, in each of these method, a high correction effect cannot be obtained if a deterioration component (blur) acting on an image is not known.

On the other hand, previously, a method of estimating a hand shake component based on a single image deteriorated by the hand shake is proposed. U.S. Pat. No. 7,616,826 discloses a method of estimating the hand shake component in the image deteriorated by the hand shake by using statistical information relating to a strength gradient distribution of a known natural image. The natural image means an image where modern people naturally see for living. Accordingly, the natural image includes not only an image of trees or animals, but also an image of humans, architectures, electronic devices, or the like. As a characteristic of the natural image, it is known that a histogram (strength gradient histogram) relating to a strength gradient of a signal follows a heavy tailed distribution depending on the strength of the gradient. U.S. Pat. No. 7,616,826 discloses a method of applying a restriction where the strength gradient histogram of the hand-shake-corrected image follows the heavy tailed distribution to estimate a hand-shake-corrected image based only on the hand shake image. A blur component is estimated based on a comparison result between the hand-shake-corrected image and the hand shake image.

As described above, however, there are various types of factors deteriorating images such as an aberration or a diffraction of an image pickup optical system and a focus shift (defocus) during photography in addition to the hand shake. Various factors that deteriorate object information are collectively called a blur.

Accordingly, a general or versatile estimation that is capable of handling a plurality of types of blurs is desired, but U.S. Pat. No. 7,616,826 discloses a method which is targeted for the hand shake, and the estimation accuracy is decreased for other types of blurs (such as an aberration and a defocus). For example, U.S. Pat. No. 7,616,826 estimates a point spread function (kernel) of the blur and then performs thresholding to perform denoising on the point spread function. However, when the thresholding is performed, weak components (components which cannot be distinguished from noises) of the point spread function are reduced at the same time. Accordingly, since the point spread function having a gently-spread shape like a defocus blur includes a lot of weak components, components other than the noises are reduced and the estimation accuracy of the blur is decreased.

When the plurality of types of blurs simultaneously act on an image, it is necessary to estimate and correct only a specific blur. For example, it is assumed that an image where a background of an object is defocused includes a deterioration caused by a hand shake. In this situation, it may be necessary to estimate and correct only the handshake component while keeping a blur (defocus blur) of the background. However, in the method disclosed in U.S. Pat. No. 7,616,826, the point spread function in which both of the defocus blur and the hand shake are mixed is estimated, and accordingly there is a possibility that the blur of the background is lost at the time of correction.

### SUMMARY OF THE INVENTION

The present invention provides an image processing apparatus, an image pickup apparatus, an image processing method, and a non-transitory computer-readable storage medium which are capable of estimating various blurs with high accuracy based on a single image.

An image processing apparatus as one aspect of the present invention includes a determiner configured to determine a characteristic of a blur to be estimated based on a blurred image, and a generator configured to acquire a blur estimation area of at least a part of the blurred image to generate an estimated blur based on the blur estimation area, and the generator is configured to repeat blur estimation processing and correction processing on information relating to a signal in the blur estimation area using the blur to generate the estimated blur, and change, depending on the characteristic of the blur, at least one of acquisition processing of the blur estimation area or the blur estimation processing, or a parameter to be used for the acquisition processing or the blur estimation processing.

An image processing apparatus as another aspect of the present invention includes a determiner configured to determine a characteristic of a blur to be estimated based on a blurred image, and a generator configured to acquire a blur estimation area of at least a part of the blurred image to generate an estimated blur based on the blur estimation area, and the generator is configured to repeat blur estimation processing and correction processing on information relating to a signal in the blur estimation area using the blur to generate the estimated blur, perform denoising processing on the estimated blur, and change, depending on the characteristic of the blur, at least one of acquisition processing of the blur estimation area, the blur estimation processing, or the denoising processing, or a parameter to be used for the acquisition processing, the blur estimation processing, or the denoising processing.

An image pickup apparatus as another aspect of the present invention includes an image pickup element configured to photoelectrically convert an optical image formed via an optical system to output an image signal, a determiner configured to determine a characteristic of a blur to be estimated based on a blurred image generated based on the image signal, and a generator configured to acquire a blur estimation area of at least a part of the blurred image to generate an estimated blur based on the blur estimation area, and the generator is configured to repeat blur estimation processing and correction processing on information relating to a signal in the blur estimation area using the blur to generate the estimated blur, and change, depending on the characteristic of the blur, at least one of acquisition processing of the blur estimation area or the blur estimation processing, or a parameter to be used for the acquisition processing or the blur estimation processing.

An image pickup apparatus as another aspect of the present invention includes an image pickup element configured to photoelectrically convert an optical image formed via an optical system to output an image signal, a determiner configured to determine a characteristic of a blur to be estimated based on a blurred image generated based on the image signal, and a generator configured to acquire a blur estimation area of at least a part of the blurred image to generate an estimated blur based on the blur estimation area, and the generator is configured to repeat blur estimation processing and correction processing on information relating to a signal in the blur estimation area using the blur to generate the estimated blur, perform denoising processing on the estimated blur, and change, depending on the characteristic of the blur, at least one of acquisition processing of the blur estimation area, the blur estimation processing, or the denoising processing, or a parameter to be used for the acquisition processing, the blur estimation processing, or the denoising processing.

An image processing method as another aspect of the present invention includes the steps of determining a characteristic of a blur to be estimated based on a blurred image, and acquiring a blur estimation area of at least a part of the blurred image to generate an estimated blur based on the blur estimation area, and the step of generating the estimated blur includes repeating blur estimation processing and correction processing on information relating to a signal in the blur estimation area using the blur to generate the estimated blur, and changing, depending on the characteristic of the blur, at least one of acquisition processing of the blur estimation area or the blur estimation processing, or a parameter to be used for the acquisition processing or the blur estimation processing.

An image processing method as another aspect of the present invention includes the steps of determining a characteristic of a blur to be estimated based on a blurred image, and acquiring a blur estimation area of at least a part of the blurred image to generate an estimated blur based on the blur estimation area, and the step of generating the estimated blur includes repeating blur estimation processing and correction processing on information relating to a signal in the blur estimation area using the blur to generate the estimated blur, performing denoising processing on the estimated blur, and changing, depending on the characteristic of the blur, at least one of acquisition processing of the blur estimation area, the blur estimation processing, or the denoising processing, or a parameter to be used for the acquisition processing, the blur estimation processing, or the denoising processing.

A non-transitory computer-readable storage medium as another aspect of the present invention stores an image processing program which causes a computer to execute the image processing method.

Further features of the present invention will become apparent from the following description of exemplary embodiments with reference to the attached drawings.

### BRIEF DESCRIPTION OF THE DRAWINGS

FIG. 1 is a flowchart of illustrating an image processing method in each of Embodiments 1 and 3.

FIG. 2 is a block diagram of an image processing system in Embodiment 1.

FIG. 3 is a diagram of a relationship between a designed aberration, and an image height and azimuth in each of Embodiments 1 to 3.

FIG. 4 is a diagram of illustrating an example of acquiring a blur estimation area relating to the designed aberration in each of Embodiments 1 to 3.

FIG. 5 is a diagram of illustrating another example of acquiring the blur estimation area relating to the designed aberration in each of Embodiments 1 to 3.

FIG. 6 is an explanatory diagram relating to symmetry of the designed aberration in each of Embodiments 1 to 3.

FIG. 7 is a flowchart of illustrating processing of acquiring a blur in each of Embodiments 1 to 3.

FIGS. 8A and 8B are diagrams of illustrating frequency characteristics of a hand shake image and a defocus image, respectively, in each of Embodiments 1 to 3.

FIG. 9 is a block diagram of an image processing system in Embodiment 2.

FIG. 10 is a flowchart of illustrating an image processing method in Embodiment 2.

FIG. 11 is a block diagram of an image pickup system in Embodiment 3.

### DESCRIPTION OF THE EMBODIMENTS

Exemplary embodiments of the present invention will be described below with reference to the accompanied drawings. In each of the drawings, the same elements will be denoted by the same reference numerals and the duplicate descriptions thereof will be omitted.

In this embodiment, factors of deteriorating information of an object space are collectively referred to as a “blur”, and the type of the blur includes a diffraction, an aberration, a defocus, a motion blur such as a hand shake and an object motion blur, and a disturbance. In this embodiment, first, the type of the blur will be described in detail.

The diffraction means a deterioration caused by a diffraction that occurs in an optical system of an image pickup apparatus which captures an image. This occurs because an opening diameter of the optical system is finite.

The aberration is a deterioration caused by a shift from an ideal wavefront that occurs in the optical system. The aberration occurring by a designed value of the optical system is called a designed aberration, and the aberration occurring by a manufacturing error of the optical system or an environmental change is called an error aberration. The environmental change means a change in temperature, humidity, atmospheric pressure, or the like, and the performance of the optical system varies depending on the change. The term “aberration” includes both of the designed aberration and the error aberration.

The defocus is a deterioration caused by a displacement between a focus point of the optical system and an object. The defocus for an entire image is called a focus shift, and the defocus for only apart of the image is called a defocus blur. Specifically, the defocus blur is a component which deteriorates information of a background on condition that there are main object and the background with different distances in the image and that the focusing is performed on the main object. The deterioration varies depending on a distance from the background to the main object in a depth direction. For example, the defocus blur is used as a representation method of emphasizing the main object in the image. The term “defocus” includes both of the focus shift and the defocus blur.

The motion blur is a deterioration generated by changing a relative relationship (position and angle) between an object and an image pickup apparatus during exposure for photography. The deterioration for an entire image is called a hand shake, and the deterioration for a part of the image is called an object motion blur. The term “motion blur” includes both of the hand shake and the object motion blur.

The disturbance is a deterioration generated by a swaying material which exists between an object and an image pickup apparatus during the photography. For example, there is the sway of air and the sway of water in underwater photography. When the disturbance occurs during a short-time exposure, the blur image includes a curved line where a straight line in an object space is swayed. In order to correct the curve, a plurality of frame images (or images obtained by continuous shots) with different disturbance components may be synthesized. However, in such synthesis processing, a deterioration of a frequency component remains while the curve of an edge can be corrected. The blurred image in this embodiment includes the synthesized image obtained by synthesizing the plurality of frames (or images obtained by the continuous shots) as described above in addition to an image (image obtained with a long-time exposure) in which the frequency component is deteriorated due to the disturbance during a single exposure.

In this embodiment, a point spread function is denoted by PSF. While processing on a one-dimensional (monochrome) image will be described in this embodiment, the embodiment can be applied also to a multidimensional (for example, RGB) image similarly and the processing may be performed for each channel of RGB. For blurs which do not have any difference between the channels or blurs with differences which are ignorable, the processing may be performed while reducing the number of the channels (for example, changing the RGB image to a monochrome image). If each channel acquires a different wavelength, the motion blur occurs as a blur without any difference between the channels.

On the other hand, the blur relating to each of the aberration, the diffraction, the defocus, and the disturbance varies depending on a wavelength. With respect to the defocus, a spread of the blur varies depending on the wavelength due to an influence of an axial chromatic aberration even when a position of the optical system is significantly away from a focus position. However, if a performance difference between the channels is sufficiently small with respect to a sampling frequency of an image pickup element being used for the photography even for the blur with the wavelength dependence, it is assumed that the difference between the channels can be ignored. When the blur where the difference between the channels can be ignored is to be estimated, it is preferred that a blur is estimated with using the plurality of channels rather than performing reduction processing of the number of the channels. The blur is estimated by using information relating to a signal gradient of an image, and accordingly the estimation accuracy is improved with increasing an amount of the information. In other words, if the blur is estimated by using the plurality of images without decreasing the number of the channels, the information of the signal gradient increases (however, if an image (i.e., wavelength) of each channel coincides with a multiple of one of the images proportionally, the information of the signal gradient does not increase), and accordingly, the blur can be estimated with higher accuracy. While an example in which the image with different wavelengths as channels is captured is described in this embodiment, the same is true for other parameters such as polarization.

### Embodiment 1

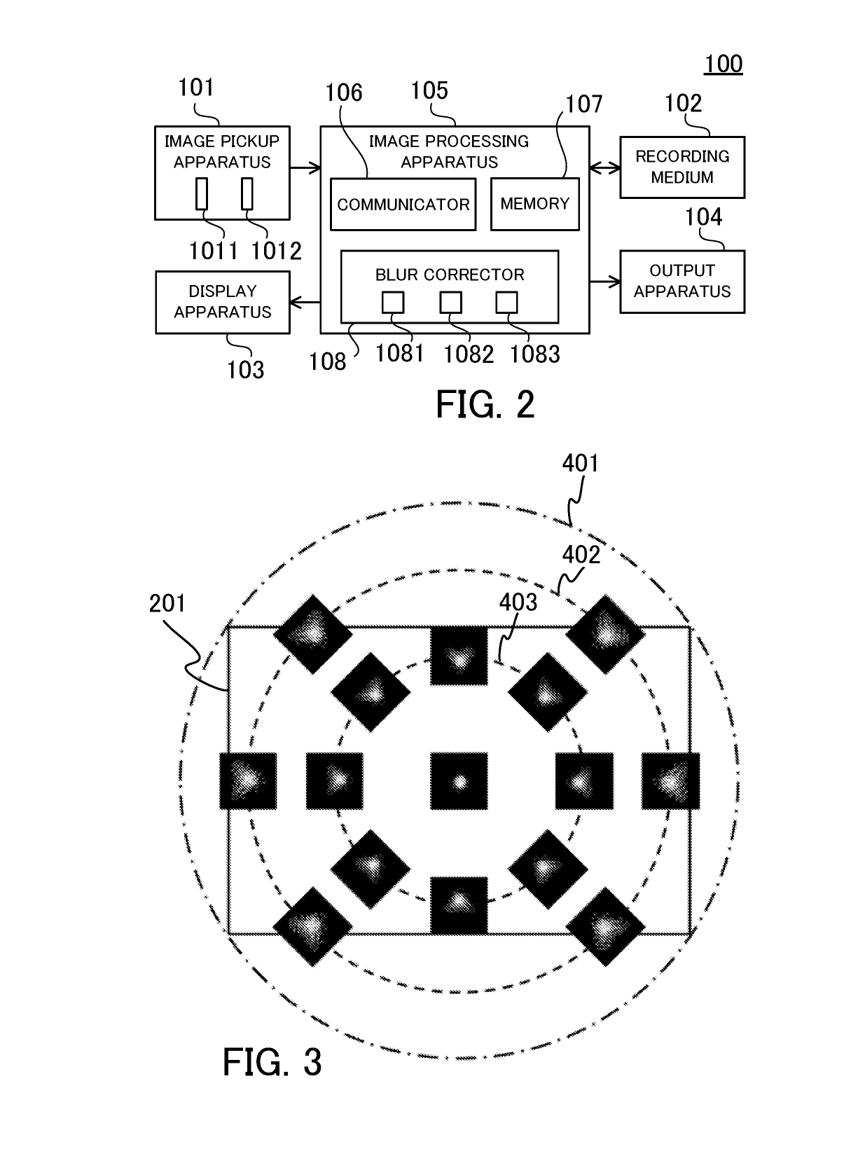

First, referring to FIG. 2, an image processing system in Embodiment 1 of the present invention will be described. FIG. 2 is a block diagram of the image processing system 100 in this embodiment.

The image processing system 100 includes an image pickup apparatus 101, a recording medium 102, a display apparatus 103, an output apparatus 104, and an image processing apparatus 105. The image processing apparatus 105 includes a communicator 106, a memory 107, and a blur corrector 108 (image processor). The blur corrector 108 includes a determiner 1081 (determination unit), a generator 1082 (generation unit), and a corrector 1083 (correction unit). Each unit of the blur corrector 108 performs an image processing method of this embodiment as described below. The image processing apparatus 105 (blur corrector 108) may be included inside the image pickup apparatus 101.

The image pickup apparatus 101 includes an optical system 1011 (image pickup optical system) and an image pickup element 1012 (image sensor). The optical system 1011 images a light ray from an object space on the image pickup element 1012. The image pickup element 1012 includes a plurality of pixels, and it photoelectrically converts an optical image (object image) formed via the optical system 1011 to output an image signal. The image pickup apparatus 101 generates a captured image (blurred image) based on the image signal output from the image pickup element 1012. The blurred image obtained by the image pickup apparatus 101 is output to the image processing apparatus 105 through the communicator 106. With respect to the blurred image, information of the object space is deteriorated due to the action of at least one of various blurs as described above.

The memory 107 stores the blurred image input to the image processing apparatus 105 and information relating to an image capturing condition determined when capturing the blurred image. The image capturing condition includes, for example, a focal length, an aperture stop, a shutter speed, and an ISO sensitivity of the image pickup apparatus 101 at the time of photography. The blur corrector 108 estimates and corrects a specific blur component based on the blurred image to generate a blur-corrected image. The blur-corrected image outputs to at least one of the display apparatus 103, the recording medium 102, and the output apparatus 104 through the communicator 106. The display apparatus 103 is for example a liquid crystal display or a projector. A user can work while confirming the image under processing through the display apparatus 103. The recording medium 102 is for example a semiconductor memory, a hard disk, or a server on a network. The output device 104 is for example a printer. The image processing apparatus 105 has a function that performs development processing and other image processing as needed.

In order to achieve the image processing method of this embodiment, software (image processing program) can be supplied to the image processing apparatus 105 through a network or a non-transitory computer-readable storage medium such as a CD-ROM. In this case, the image processing program is read out by a computer (such as a CPU and a MPU) of the image processing apparatus 105 to execute a function of the blur corrector 108.

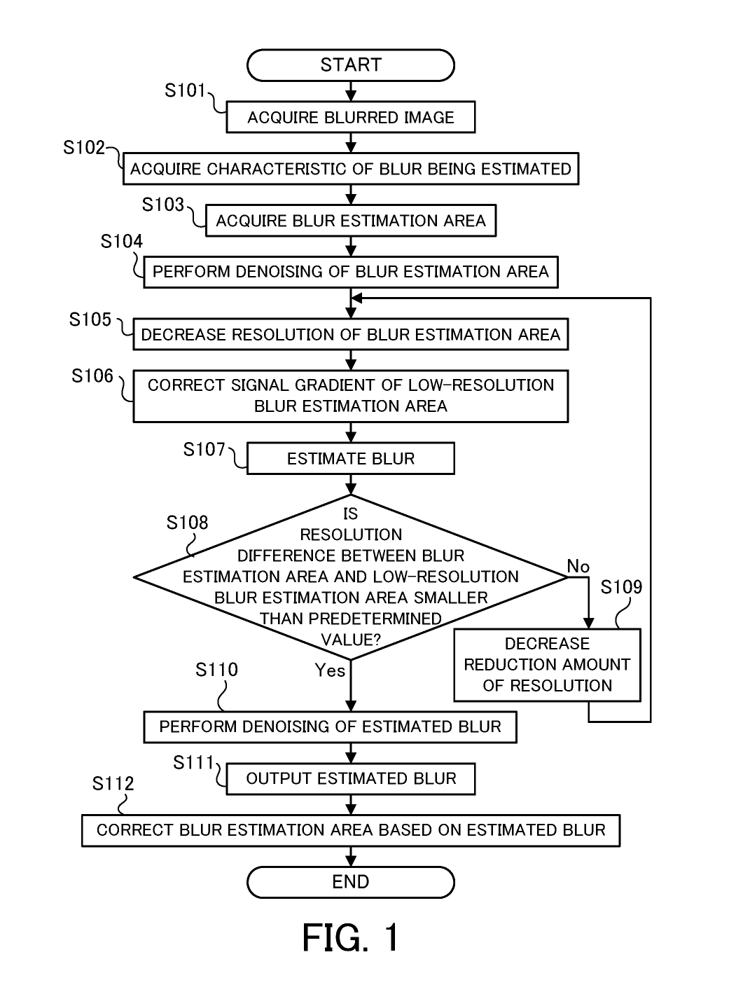

Next, referring to FIG. 1, the image processing which is performed by the blur corrector 108 will be described. FIG. 1 is a flowchart of illustrating an image processing method in this embodiment. Each step in FIG. 1 is performed by the determiner 1081, the generator 1082, and the corrector 1083 of the blur corrector 108.

First, at step S101, the determiner 1081 of the blur corrector 108 determines (acquires) a blurred image (captured image). Subsequently, at step S102, the determiner 1081 determines (acquires) a characteristic such as a designed aberration, an error aberration, a diffraction, a defocus (focus shift), a defocus blur, a hand shake, an object motion blur, and a disturbance of a blur to be estimated and corrected. As the characteristic of the blur, a characteristic which is automatically determined may be acquired, or alternatively a characteristic which is manually determined by a user may be acquired. In this case, in order to assist determining the characteristic automatically or manually, information relating to a frequency characteristic of the blurred image or the image capturing condition is used. Details will be described below.

Subsequently, at step S103, the generator 1082 of the blur corrector 108 acquires a blur estimation area in the blurred image (processing of determining the blur estimation area). The generator 1082 assumes that an identical blur (uniform blur) acts on the blur estimation area to estimate the blur. A method of acquiring the blur estimation area changes depending on the characteristic of the blur acquired at step S102. Hereinafter, an example will be described.

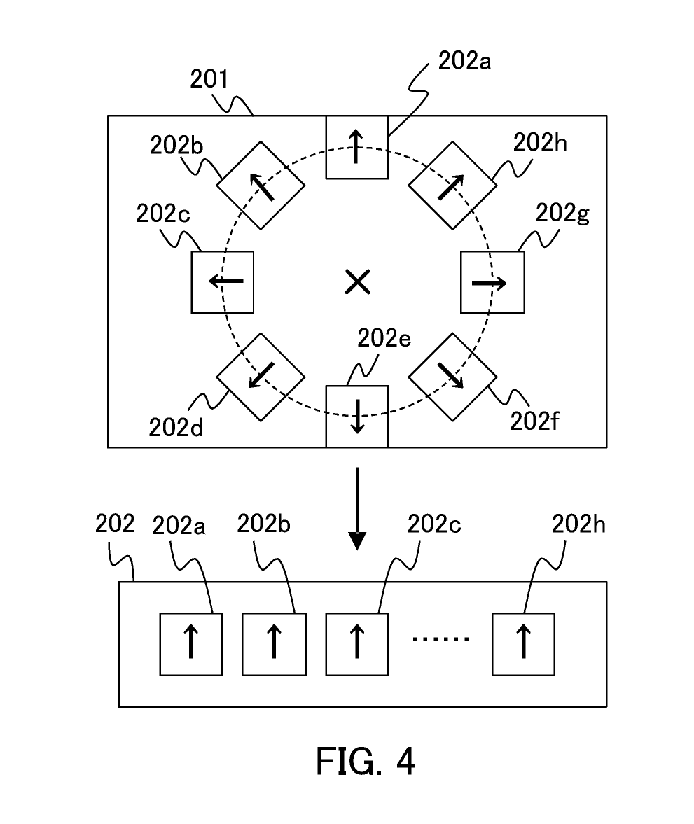

First, a case in which the characteristic of the blur is the designed aberration will be described. The optical system 1011 of the image pickup apparatus 101 includes lenses each having a rotationally-symmetric shape with respect to the optical axis. Accordingly, the designed aberration has a rotational symmetry with respect to the azimuth while it varies depending on an image height as illustrated in FIG. 3. FIG. 3 is a diagram of a relationship between the designed aberration, and the image height and the azimuth, and it illustrates a change of the PSF of the designed aberration for a blurred image 201. In FIG. 3, a circle 401 with a dashed-dotted line indicates an image circle of the optical system 1011, and circles 402 and 403 with dashed lines indicate the same image height. The PSFs relating to the same image height match each other by rotation. As illustrated in FIG. 4, a plurality of partial areas 202a to 202h are acquired from the same image height, and an area which is obtained by rotating and collecting each of the partial areas is a blur estimation area 202 to estimate the designed aberration at this image height. FIG. 4 is a diagram of illustrating an example of acquiring the blur estimation area 202 relating to the designed aberration.

The accuracy of the estimation of the blur is improved with increasing an amount of the information (i.e., blur estimation area 202) in the image to be used for estimating the blur. Accordingly, the high-accuracy estimation can be performed by estimating the PSF relating to the blur estimation area 202 combining the partial areas 202a to 202h rather than estimating the PSF individually relating to each of the partial areas 202a to 202h. In FIG. 4, arrows in the partial areas 202a to 202h are illustrated to easily understand rotation processing that is performed when the partial areas 202a to 202h are collected as the blur estimation area 202. In the example illustrated in FIG. 4, while eight partial areas 202a to 202h are acquired for each image height, the number of the partial areas is not limited thereto. It is necessary to acquire the partial areas at equal intervals, and the plurality of partial areas may overlap with each other. The image height is not limited to a position illustrated in FIG. 4.

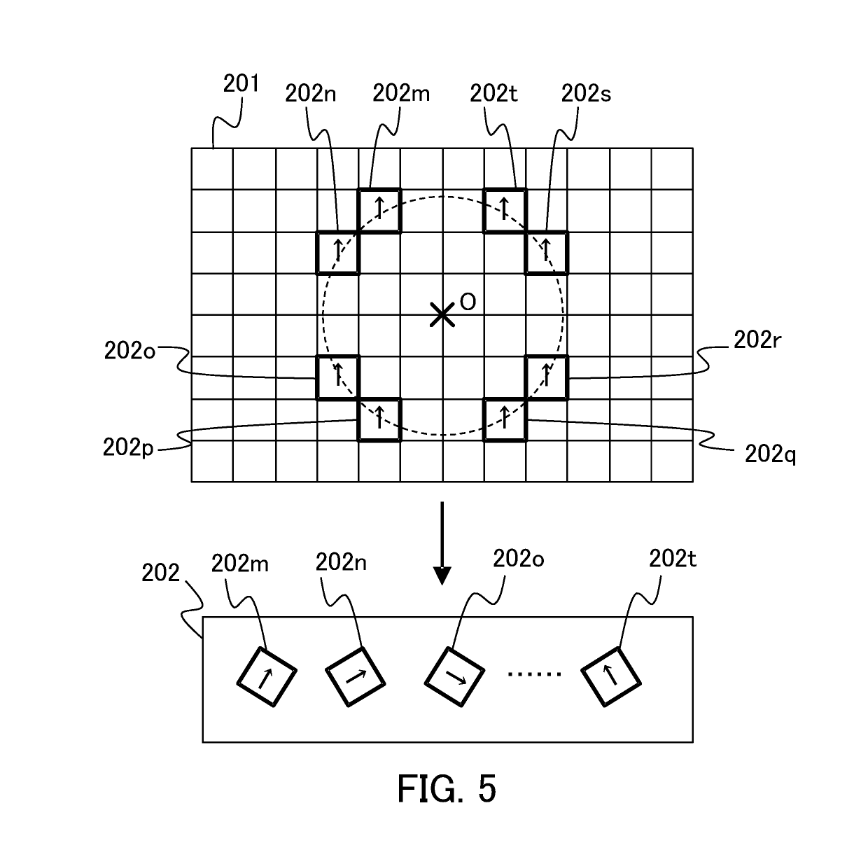

The example of acquiring the blur estimation area 202 in this embodiment is not limited to the method illustrated in FIG. 4, and other methods may be used. FIG. 5 is a diagram of illustrating another example of acquiring the blur estimation area 202 relating to the designed aberration. In FIG. 5, partial areas 202m to 202t having approximately the same distance from the center O are extracted from the blurred image 201 including areas divided at equal pitches, and each of the partial areas are rotated to be collected to acquire the blur estimation area 202. In FIG. 5, arrows in the partial areas 202m to 202t are illustrated to easily understand the rotation processing as described above.

Next, a case in which the characteristic of the blur is the error aberration will be described. When the error occurs in the optical system 1011, in many cases, the optical system 1011 loses the rotational symmetry. Accordingly, the aberration of the optical system 1011 loses the symmetry with respect to the azimuth direction. The rotational symmetry is maintained only for an error in the optical axis direction (such as expansion and contraction due to a shift of a lens in the optical axis direction or a temperature change). Accordingly, when the error aberration is to be estimated and corrected, the blurred image is divided into some areas and each area is set as another blur estimation area. In this embodiment, when information relating to the image capturing condition includes information relating to the error of the optical system 1011, it is preferred that the information is reflected to acquire the blur estimation area. The information relating to the error of the optical system 1011 can be acquired by taking a chart photograph in advance.

Next, a case in which the characteristic of the blur is the diffraction will be described. In this case, the PSF is approximately a constant independently of a position in the blurred image. Accordingly, a whole of the blurred image is set as a blur estimation area. However, PSFs of the different diffractions depending on the image height in the blurred image acts on an optical system such as a lens with a large diameter in which vignetting greatly changes depending on the image height. In this case, information relating to the image pickup apparatus 101 (the optical system 1011 and the image pickup element 1012) is acquired from the image capturing condition, and it is determined that an influence of the diffraction change caused by the image height of the optical system 1011 on a pixel pitch of the image pickup element 1012. If the influence of the diffraction change is ignorable, the whole of the burred image is set as a blur estimation area. On the other hand, if the influence of the diffraction change cannot be ignored, similarly to the designed aberration, the blur estimation area may be acquired for each image height.

Next, a case in which the characteristic of the blur is the defocus (focus shift) will be described. In this case, information relating to a focus point (focus position) determined during the photography based on the image capturing condition, and an area around the focus point is set as a blur estimation area. This is because there is a high possibility that an object as a target to be focused by a user exists near the focus point. Alternatively, a whole of the blurred image may be set as the blur estimation area.

Next, a case in which the characteristic of the blur is the defocus blur will be described. In this case, the blurred image is segmented (divided) into a plurality of areas to set the same area (a single area) as a blur estimation area. This is because that is a high possibility that each segmented area (i.e., an object included in each area) is located at the same depth. The segmentation may be performed by using for example a graph cut. In order to further improve the accuracy, it is preferred that distance information of the object space corresponding to the blurred image is acquired to determine the blur estimation area according to the distance information. As a method of acquiring the distance information, for example a method of using a range-finding apparatus including a laser or the like, a method of using DFD (Depth From Defocus), a method of using TOF (Time Of Flight), or a method of using a multi-viewpoint image pickup system such as a multi-eye camera is used.

Next, a case in which the characteristic of the blur is the hand shake will be described. When a hand shake component is weak or it is uniform, which is called Shift-invariant, in a whole of the blurred image, the whole of the blurred image is set as a blur estimation area. Whether the hand shake component is weak or it is uniform in the whole of the blurred image is determined based on the image capturing condition. For example, the easiness of occurrence of the hand shake can be estimated based on a relationship between a focal length of the optical system 1011 and a shutter speed during the photography. The hand shake tends to occur with increasing the focal length and with decreasing the shutter speed (i.e., increasing the exposure time). On the other hand, the hand shake does not easily occur when the focal length is short and the shutter speed is high. Accordingly, in this case, it can be determined that the hand shake component is weak. The image pickup apparatus 101 can be provided with a gyro sensor (angular velocity sensor) to acquire a motion (motion information) of the image pickup apparatus 101, as information relating to the image capturing condition, during the photography. Based on the motion information, whether the hand shake is strong or weak or whether the blur in the whole of the blurred image is uniform or non-uniform (Shift-variant) can be determined. As described below, based on a frequency characteristic of the blurred image, whether the hand shake is strong or weak or whether the blur is Shift-variant or not can be determined. When the hand shake component is strong or it is Shift-variant, the blurred image is divided into a plurality of partial areas, and a partial area of the plurality of divided partial areas is set as a blur estimation area.

Next, a case in which the characteristic of the blur is the object motion blur will be described. In this case, a blurring object area is extracted to be set as a blur estimation area. As a method of extracting the object area, for example, there is a method disclosed in US Patent Application Publication No. 2013/0271616. When the characteristic of the blur is the motion blur (hand shake or object motion blur), as described above, the PSF does not vary depending on the wavelength. Accordingly, it is preferred that a plurality of partial areas are acquired from the same position in a plurality of channel (RGB) images to be collected as a blur estimation area. As a result, the estimation accuracy of the blur is improved. As described above, if the difference between the channels can be ignored, similar processing can be performed on blurs having other characteristics.

Next, a case in which the characteristic of the blur is the disturbance will be described. In this case, information relating to an exposure time (total exposure time of each of images being synthesized if the blurred image is the synthesized image described above) during the photography is acquired based on the image capturing condition, and a blur estimation area is changed depending on the exposure time. When the exposure time is sufficiently long, it is considered that the PSF of the disturbance in a whole of the blurred image is uniform. Accordingly, the whole of the blurred image is set as a blur estimation area. In other cases, the blurred image is divided into a plurality of partial areas, and one of the divided partial areas is set as a blur estimation area. If it is necessary to estimate a plurality of types (characteristics) of blurs at the same time, for example, it is preferred that a blur estimation area relating to the characteristic of the blur where the blur estimation area is smallest is adopted.

Subsequently, at step S104 in FIG. 1, the generator 1082 performs denoising of the blur estimation area. The denoising of the blur estimation area is performed to reduce a deterioration of an estimation accuracy of the blur, which is caused by the existence of the noise in the blur estimation area. Instead of step S104, a step of denoising a whole of the blurred image may be inserted prior to step S103 of acquiring the blur estimation area. As a denoising method, a method of using a bilateral filter, a NLM (Non Local Means) filter, or the like may be used.

Preferably, the generator 1082 performs the denoising of the blur estimation area by the following method. First, the generator 1082 performs frequency decomposition (frequency resolution) of the blur estimation area to generate a frequency-resolved blur estimation area. Then, the generator 1082 performs the denoising of the frequency-resolved blur estimation area based on a noise amount in the blur estimation area. Next, the generator 1082 resynthesizes the frequency-resolved blur estimation area to acquire a noise-reduced blur estimation area. Typically, in addition to an effect of reduction of a noise in an image, the denoising processing has a problem that causes a blur of the image. If the blur estimation area is blurred by the denoising, a PSF where a blur acquired at step S102 is mixed with a blur caused by the denoising is estimated when performing estimation processing (blur estimation processing) at the latter stage. Accordingly, it is preferred that a denoising method in which an amount of a blur given to the image is small. As such a method, denoising processing with the use of the frequency decomposition of an image is applied. In this embodiment, an example where wavelet transform is used as the frequency decomposition will be described. The detail is described in “Donoho D. L., ‘De-noising by soft-thresholding’, IEEE Trans. on Inf. Theory, 41, 3, pp. 613-627”.

The wavelet transform is a transformation in which a frequency analysis is performed for each position in an image by using a localized small wave (wavelet) to resolve a signal into a high frequency component and a low frequency component. In the wavelet transform of an image, the wavelet transform is performed in a horizontal direction of the image to resolve the image in the low frequency component and the high frequency component, and further the wavelet transform is performed in a vertical direction of the resolved low frequency component and high frequency component. According to the wavelet transform, the image is divided into four areas, and thus four sub-band images with different frequency bands from each other is obtained by the frequency decomposition. In this case, a sub-band image of a low frequency band component (scaling coefficient) at the upper left is denoted by LL1, and a sub-band image of a high frequency band component (wavelet coefficient) at the lower right is denoted by HH1. Sub-band images at the upper right (HL1) and at the lower left (LH1) correspond to an image obtained by extracting the high frequency band component in the horizontal direction and the low frequency band component in the vertical direction, and an image obtained by extracting the low frequency band component in the horizontal direction and the high frequency band component in the vertical direction, respectively.

Furthermore, when the wavelet transform is performed on the sub-band image LL1, the image size halves to be resolved into sub-band images LL2, HL2, LH2, and HH2, and accordingly the resolved sub-band image LL can be resolved by the number of times of a transformation level.

As a method of performing noise reduction processing by using the wavelet transform, thresholding is known. In the thresholding, a component which is smaller than a set threshold value is regarded as a noise, and the noise is reduced. Threshold value processing in the wavelet space is performed on sub-band images other than the sub-band image LL, and as represented by expression (1) below, a wavelet coefficient w_{subband} (x,y) having an absolute value not greater than a threshold value is replaced with zero to perform the denoising.

$${w}_{subband} ( x , y ) = \{ \begin{matrix}{w}_{subband} ( x , y ) & , if \vert {w}_{subband} ( x , y ) \vert > {ρ}_{subband} σ \\ 0 & , if \vert {w}_{subband} ( x , y ) \vert \leq {ρ}_{subband} σ\end{matrix} \qquad ( 1 )$$

In expression (1), symbols x and y denote vertical and horizontal coordinates in an image, symbol ρ_{subband} denotes a weight parameter, and symbol σ denotes a standard deviation of the noise (noise amount). The noise amount σ included in the blur estimation area is obtained by measurement or estimation based on the blur estimation area. If the noise is white Gaussian noise that is uniform in a real space and a frequency space, a method of estimating the noise in the blur estimation area based on MAD (Median Absolute Deviation) as represented by expression (2) below is known.

MAD=median(|w_{HH1}−median(w_{HH1})|) (2)

The MAD is obtained by using the median (central value) of a wavelet coefficient w_{HH1} in the sub-band image HH1 obtained by the wavelet transform of the blur estimation area. The standard deviation and the MAD have a relationship represented by expression (3) below, and accordingly the standard deviation of the noise component can be estimated.

$$σ = \frac{MAD}{0.6745} \qquad ( 3 )$$

The noise amount σ may be acquired based on an ISO sensitivity during the photography, instead of using expressions (2) and (3).

Subsequently, at step S105, the generator 1082 reduces a resolution of the blur estimation area to generate a low-resolution blur estimation area. With a reduction of the resolution of the blur estimation area, the resolution of the blur being estimated is reduced similarly. As a result, a convergence of the blur estimation described below is improved, and the possibility that the estimation result is a local solution which is different from an optimum solution can be reduced. A rate of decreasing the resolution in the blur estimation area is determined depending on a down-sampling parameter. While Step S105 is performed a plurality of times by loop processing (i.e., iterative calculation), at the time of a first execution, a prescribed down-sampling parameter is used. At the time of a second and subsequent executions, the low-resolution blur estimation area is generated by using a down-sampling parameter set at step S109 described below. A reduction amount of the resolution decreases with increasing the number of times of the iterations of the loop, and the resolution of the low-resolution blur estimation area comes close to the blur estimation area. In other words, first, a low-resolution blur is estimated, and the estimation result is set as an initial value to repeat (iterate) the estimation while increasing the resolution gradually. As a result, an optimum blur can be estimated while the local solution is avoided. The resolution of the low-resolution blur estimation area is not higher than the resolution of the blur estimation area, and both of the resolutions may be equal to each other.

Subsequently, at step S106, the generator 1082 corrects a blur of the signal gradient in the low-resolution blur estimation area to generate a blur-corrected signal gradient (processing of correcting information relating to a signal in the blur estimation area). In the blur correction, it is preferred that a method of using an inverse filter such as Wiener filter or a super-resolution method such as Richardson-Lucy method is used. In this embodiment, according to super-resolution processing of obtaining a solution of an optimization problem described below, the blur-corrected signal gradient is estimated.

A relationship between the low-resolution blur estimation area and the blur is represented by expression (4) below.

bᵢ=kᵢ*aᵢ+nᵢ (4)

In expression (4), symbol bᵢ denotes a signal distribution in the low-resolution blur estimation area in the i-th loop processing, symbol kᵢ denotes a blur, symbol aᵢ denotes a signal distribution without the deterioration caused by the blur kᵢ, and symbol nᵢ denotes a noise. As described above, the resolutions of the signal distributions bᵢ and aᵢ increase with increasing the number of times of iteration of the loop (with increasing the number i). Symbol “*” represents a convolution. While the blur is estimated in the form of the PSF, this embodiment is not limited thereto. For example, the blur may be estimated in the form of an OTF (Optical Transfer Function) that is obtained by performing the Fourier transform of the PSF.

By solving the optimization problem that is represented by expression (5) below, an estimation value dᵢ of the signal distribution aᵢ in the i-th loop processing is estimated.

$${argmin}_{{d}_{i}} [ L ( {k}_{i} * {d}_{i} ) + Φ ( {d}_{i} ) ] \qquad ( 5 )$$

In expression (5), symbol L denotes a loss function and symbol Φ denotes a regularization term for the estimation value dᵢ, and each specific example will be described below. The loss function L has an effect of fitting a solution into a model (expression (4)). The regularization term Φ has an effect of converging a solution into a most likely value. For the regularization term Φ, a characteristic that the solution (aᵢ) called a previous knowledge is to have is used. The regularization term Φ has a role of avoiding excessive fitting (i.e., avoiding reflection of the influence of the noise nᵢ to the estimation value dᵢ) which occurs when the loss function L is only considered.

Next, a specific example of the loss function L and the regularization term Φ in expression (5) will be described. As the loss function L, a function represented by expression (6) below is considered.

L(kᵢ*dᵢ)=∥kᵢ*dᵢ−bᵢ∥₂² (6)

In expression (6), a symbol represented by expression (7) below represents a p-th order average norm (L_{—p} norm), and it indicates the Euclidean norm when p is equal to 2 (p=2).

∥.∥ₚ (7)

As an example of the regularization term Φ, a first-order average norm represented by expression (8) below is presented.

Φ(dᵢ)=λ∥Ψ(dᵢ)∥₁ (8)

In expression (8), symbol λ is a parameter that represents a weight of the regularization term Φ, and symbol Ψ is a function that represents a change of basis for an image such as wavelet transform and discrete cosine transform. The regularization term Φ in expression (8) is based on a characteristic that a signal component becomes sparse, that is, it can be represented by the smaller number of signals by performing the change of basis such as the wavelet transform and the discrete cosine transform on an image. For example, this is described in “Richard G. Baraniuk, ‘Compressive Sensing’, IEEE SIGNAL PROCESSING MAGAZINE [118] JULY 2007”. As other examples of the regularization term, Tikhonov regularization term or TV (Total Variation) norm regularization term may be used.

In order to solve the estimation expression represented by expression (5) as an optimization problem, by using a method of using the iterative calculation, for example a conjugate gradient method may be used when the Tikhonov regularization term is adopted. When expression (8) or the TV norm regularization term is adopted, for example TwIST (Two-step Iterative Shrinkage/Thresholding) may be used. TwIST is described in “J. M. Bioucas-Dias, et al., ‘A new TwIST: two-step iterative shrinkage/thresholding algorithms for image restoration’, IEEE Trans. on Image Processing, vol. 16, Dec. 2007”.

When the iterative calculation is performed, a parameter such as a weight of the regularization may be updated for each iteration. While expressions (4) and (5) are represented for an image (signal distribution), they are satisfied similarly for a differential of the image. Accordingly, instead of the image, blur correction may be performed for the differential of the image (both of the image and the differential of the image are represented as a signal gradient).

The result (blur) estimated at step S107 in a previous loop is used for the blur kᵢ being used for the inverse filter or the super-resolution processing. At the first of the loop, a PSF having an appropriate shape (for example, gauss distribution for the aberration and the defocus, and vertical and horizontal lines for the motion blur) is used as the blur kᵢ. In addition to the inverse filter or the super-resolution processing, a blur-corrected signal gradient may be generated by applying a tapered filter such as a shock filter. Furthermore, when the tapered filter is applied as well, for example a bilateral filter or a guided filter may be used to suppress noise or ringing while a sense of resolution of an edge is maintained.

Subsequently, at step S107, the generator 1082 estimates the blur based on the signal gradient in the low-resolution blur estimation area and the blur-corrected signal gradient (blur estimation processing). Hereinafter, a method of estimating the blur will be specifically described. Similarly to expression (5), the PSF can be estimated by using expression (9) below.

$${argmin}_{{k}_{i}} [ L ( {k}_{i} * {d}_{i} ) + Φ ( {k}_{i} ) ] \qquad ( 9 )$$

If the blur estimation area is acquired from a plurality of channels (i.e., if the blur does not vary depending on the channel, or the change of the blur depending on the channel can be ignored), expression (9) is deformed as represented by expression (9a) below.

$${argmin}_{{k}_{i}} [ {\sum }_{h = 1}^{H} {v}_{h} L ( {k}_{i} * {d}_{i , h} ) + Φ ( {k}_{i} ) ] \qquad ( 9 a )$$

In expression (9a), symbol H denotes the total number of the channels included in the blur estimation area, symbol d_{i,h} denotes dᵢ for the h-th channel, and symbol vₕ denotes a weight. While expression (5) is solved for each channel in the correction of the signal gradient, a form which is collected by all channels as represented by expression (9a) is used in the blur estimation. This is because targets to be estimated are common (i.e., the same PSF) in expression (9a) while the targets are different in each channels in expression (5).

As the loss function L in each of expressions (9) and (9a), expression (10) below is considered.

$$L ( {k}_{i} * {d}_{i} ) = {\sum }_{j} {u}_{j} {‖ {k}_{i} * {\partial }_{j} {d}_{i} - {\partial }_{j} {b}_{i} ‖}_{2}^{2} \qquad ( 10 )$$

In expression (10), symbol ∂ⱼ denotes a differential operator. Symbol ∂₀ (j=0) denotes an identity operator, and symbols ∂ₓ and ∂_{y} denote differentials in a horizontal direction and a vertical direction of an image, respectively. A higher order differential is denoted by for example ∂ₓₓ or ∂_{xyy}. While the signal gradient of the blur estimation area includes all of “j” (j=0,x,y,xx,xy,yy,yx,xxx, . . . ), this embodiment considers only the case of j=x,y. Symbol uⱼ denotes a weight.

The generator 1082 applies a restriction reflecting the characteristic of the blur acquired at step S102 (i.e., characteristic of the blur being estimated). Accordingly, the estimation accuracy of the acquired blur having a specific characteristic can be improved. If a plurality of types of blurs are simultaneously acquired as characteristics of the blurs at step S102, it is preferred that the following restriction are applied at the same time. However, if contradictory restrictions occur, it is preferred that the looser restriction is adopted.

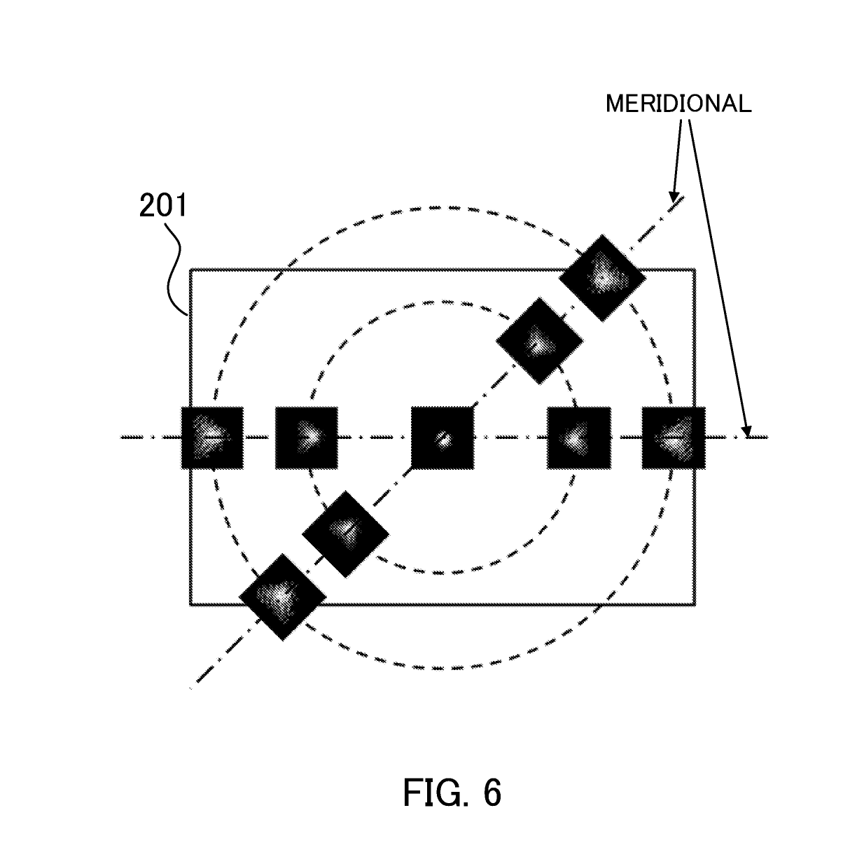

When the characteristic of the blur acquired at step S102 is the designed aberration, the PSF has a reversal symmetry with respect to a meridional axis (dashed-dotted line in FIG. 6). FIG. 6 is an explanatory diagram of the symmetry of the designed aberration. In FIG. 6, a dashed-dotted line indicates the meridional axis. Accordingly, this embodiment applies a restriction such that the blur being estimated has the reversal symmetry. If all the partial areas having different azimuths at the same image height are not set as one blur estimation area at step S103, a restriction where estimated blurs, estimated at step S107, in blur estimation areas having different azimuths at the same image height coincide with each other by rotation around the optical axis may be applied. The PSF of the aberration (including the error aberration) continuously varies depending a change of the image height, and accordingly a restriction where blurs estimated in adjacent blur estimation areas continuously vary may be applied.

Next, a case in which the characteristic of the blur is the diffraction will be described. If the PSF is Shift-invariant and the opening of the optical system 1011 of the image pickup apparatus 101 has approximately a circle shape, the PSF also has rotational symmetry. Accordingly, it is preferred that a restriction is applied such that the blur is rotationally symmetric. Alternatively, a restriction may be applied such that the blur can be represented by the Bessel function of the first kind. If the PSF is Shift-variant according to the vignetting, similarly to the case designed aberration, the restriction may be applied such that the blur has the reversal symmetry with respect to the meridional axis. The size of the vignetting can be acquired from information relating to the image capturing condition.

If the characteristic of the blur is the defocus, with respect to an optical system having small vignetting, similarly to the case described above, a restriction where the PSF is rotationally symmetric is applied to estimate the blur. On the other hand, when the vignetting is large, similarly to the diffraction, a restriction is applied such that the blur has the reversal symmetry with respect to the meridional axis. Since the PSF of the defocus has a gentle shape, it is preferred that the regularization term Φ(kᵢ) is used such that the strength gradient of kᵢ is weakened in expression (9) or (9a). For example, there is TV norm regularization which is represented by expression (11) below.

Φ(kᵢ)=ζ∥∇kᵢ∥_{TV}=ζ\sqrt{(∂ₓkᵢ)²+(∂_{y}kᵢ)²} (11)

In expression (11), symbol ζ denotes a weight of the regularization term. The TV norm regularization has an effect that decreases a total sum of absolute values in a differential (strength gradient) of kᵢ. Accordingly, by using the regularization of expression (11), the gentle PSF of the defocus can be easily estimated.

If distance information of the blur estimation area is known to some extent, an amount (size) of the defocus can be estimated based on a focal length and an F number of the optical system as image capturing conditions, an in-focus distance, and the distance information. Accordingly, by restricting the size, it is possible to estimate the blur with higher accuracy.

When the characteristic of the blur is the motion blur, the PSF has a linear shape, and accordingly a restriction reflecting the shape is applied to be able to improve the accuracy of the PSF. For example, it is preferred that the regularization term Φ(kᵢ) is used such that a component of kᵢ is reduced (i.e., sparse) as much as possible in expression (9) or (9a). In this case, a first-order averaged norm regularization as represented by expression (12) below is used.

Φ(kᵢ)=ζ∥kᵢ∥₁ (12)

Alternatively, each of edges (having characteristics of linear shapes) in various directions may be set as a basis, and a restriction where a partial area of the PSF of the motion blur can be sparsely represented by the basis may be used to improve the estimation accuracy.

When the motion blur is Shift-variant, similarly to the aberration, the PSF of the motion blur continuously changes in the adjacent blur estimation areas, and accordingly a restriction of the continuous change can be applied to improve the estimation accuracy. Furthermore, the blurred image can be represented by performing geometric transform (shift and rotation) on still images to overlap the images. Accordingly, the estimation accuracy can be improved by applying the restriction where the blur estimation area (blurred image) can be represented by the synthesis (combination) of the geometric transforms of the blur-corrected signal gradients (still images).

When the characteristic of the blur is the disturbance, similarly to the defocus, the PSF has a gentle strength gradient. Accordingly, it is preferred that the regularization where the strength gradient of the PSF is weakened for example as represented by expression (11) is adopted in expression (9) or (9a). The regularization term in expression (9) or (9a) acts on a frequency characteristic of a target to be estimated (in this embodiment, kᵢ). Typically, the estimated PSF is sharpened with decreasing the weight of the regularization, and a blurred PSF having low frequencies is obtained if the weight increases. Accordingly, the weight of the regularization term Φ is enhanced if the type of the blur is the defocus or the disturbance, and on the other hand the weight of the regularization term Φ is weakened if the type of the blur is the motion blur, and thus the accuracy of the estimated blur is improved.

Subsequently, at step S108, the generator 1082 determines whether or not the iterative calculation is completed. This determination is performed by comparing the resolution of the blur estimation area with the resolution of the low-resolution blur estimation area. A difference between both the resolutions is smaller than a predetermined value, the iterative calculation is completed. Then, the blur estimated at step S107 is regarded as a final estimated blur, and the flow proceeds to step S110. Whether or not an absolute value of the difference between both of the resolutions is smaller than the predetermined value is determined, for example, depending on whether the absolute value of the difference between both of the resolutions is smaller than the predetermined value or whether a ratio of both of the resolutions is closer to 1 than a predetermined value is. If a predetermined condition is not satisfied (for example, if the absolute value of the difference between both of the resolutions is larger than the predetermined value), the resolution of the estimated blur is still insufficient, and accordingly the flow proceeds to step S109 to perform the iterative calculation.

At step S109, the generator 1082 sets a down-sampling parameter that is to be used at step S105. In order to increase the resolution through the iterative processing of steps S105 to S107, the parameter is set to decrease a degree of the down-sampling (i.e., to decrease a resolution reduction amount) compared with the previous loop. In the iterative calculation, a blur estimated at step S107 in the previous loop is used, and in this case the resolution of the blur needs to be increased. In order to improve the resolution, it is preferred that bilinear interpolation or bicubic interpolation is used.

At step S110, the generator 1082 performs denoising of the blur (estimated blur) estimated at step S107. As represented by expression (4), a noise occurs in the blur estimation area, and according to the influence, a noise occurs in the estimated PSF as well. Therefore, while performing denoising processing, the generator 1082 changes the denoising processing or a parameter depending on the characteristic of the blur acquired at step S102 to perform a noise reduction with high accuracy. Hereinafter, this example will be described.

If the blur has a characteristic of a small high-frequency component like the defocus, it is preferred that a combination of a low-pass filter such as a Gaussian filter, and thresholding is used. When the low-pass filter is applied in advance, the intensity of the noise of the PSF is reduced, and accordingly a threshold value of the thresholding can be decreased. As a result, the elimination of an area where the PSF is a small value, as well as the noise, during the denoising processing is suppressed.

If a blur other than each of the blurs described above is targeted, it is preferred that the noise reduction is performed by the thresholding or opening. The opening is removal processing of an isolated point by using the morphology operation. When a low-pass filter is applied to a blur having a high frequency component, a shape of the PSF largely collapses due to the deterioration of the high frequency component. If a blurred image is restored by using the blurred PSF (having a small amount of the high frequency component) compared with an original PSF, the correction is excessive, which brings a harmful effect such as ringing. Accordingly, if the low-pass filter is to be used, it is preferred that the strength of the low-pass filter for a blur having a high frequency component is weakened compared with that for a blur having only a low frequency component. More preferably, denoising processing is performed without using the low-pass filter in the thresholding or the opening. According to each of the thresholding or the opening, a noise can be reduced without deteriorating the high frequency component of the PSF. Particularly, since the opening is processing of removing the isolated point, the noise can be removed without removing a weak component that exists around the original PSF component. Accordingly, it is preferred that the opening is used in the denoising processing. However, if the opening is performed on a PSF having a small spread, all of PSF components may be removed. When all the components become zero, it is preferred that the thresholding is adopted instead of the opening.

Subsequently, at step S111, the generator 1082 outputs the estimated blur which is denoised at step S110. In this embodiment, the estimated blur is PSF data. However, this embodiment is not limited thereto, and the estimated blur may be output as an OTF obtained by converting the PSF, coefficient data obtained by fitting the PSF or the OTF with a certain basis, or an image obtained by converting the PSF or the OTF into image data.

Subsequently, at step S112, the blur corrector 108 (corrector 1083) corrects the blur estimation area (blur included in the blur estimation area) by using the estimated blur output at step S111. Similarly to step S106, it is preferred that a method of using an inverse filter such as Wiener filter, a method of performing optimization with the use of expression (5), or a super-resolution method such as Richardson-Lucy method is used in this correction. According to the processing, various blurs can be estimated and corrected with high accuracy based on a signal image.

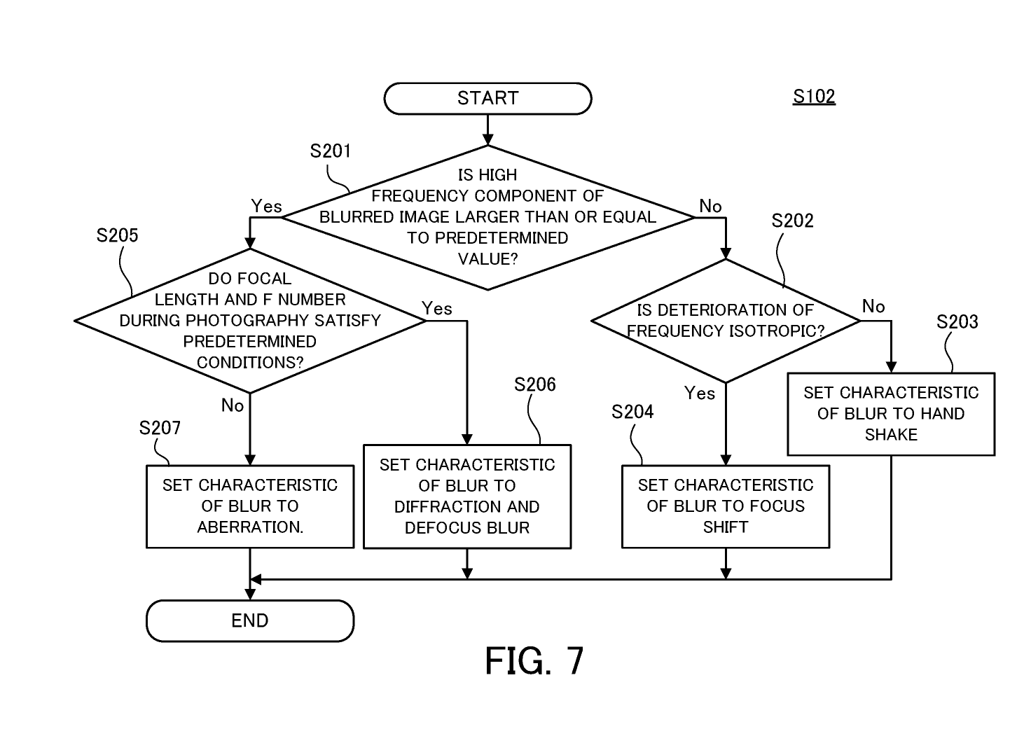

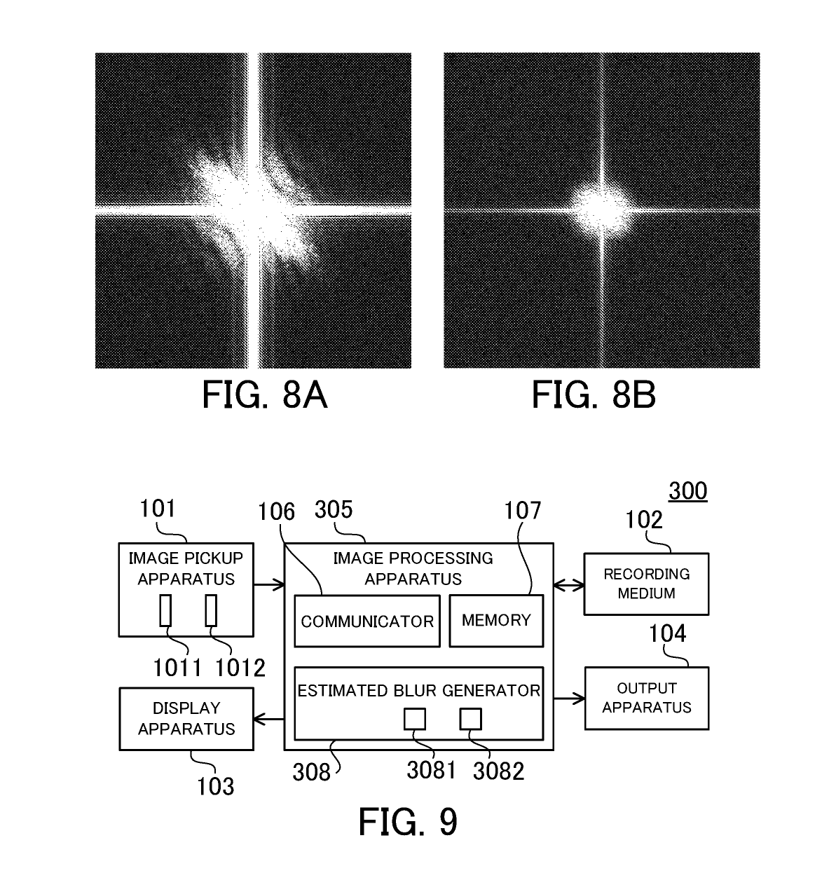

Next, referring to FIG. 7 and FIGS. 8A and 8B, the method of automatically determining the characteristic of the blur to be estimated, or assisting manually determining the characteristic of the blur, which is described at step S102 in FIG. 1, will be described in detail. FIG. 7 is a flowchart of illustrating the processing of acquiring the characteristic of the blur to be estimated (step S102). FIGS. 8A and 8B are diagrams of frequency characteristics of a hand shake image and a defocus image (focus shift image), respectively.

In this embodiment, according to the flowchart illustrated in FIG. 7, the blur corrector 108 (determiner 1081) determines (acquires) the characteristic of the blur to be corrected based on the blurred image acquired at step S101. In this embodiment, the characteristic of the blur includes an aberration, a diffraction, a defocus (focus shift), a defocus blur, and a hand shake, but it is not limited thereto.

First, at step S201, the blur corrector 108 determines whether or not a high frequency component (amount of the high frequency component) is larger than or equal to a predetermined value based on the frequency characteristic of the blurred image. The frequency (high frequency component) as a reference of this determination is for example a Nyquist frequency of the image pickup element 1012 of the image pickup apparatus 101 or a frequency depending on an optical performance of the optical system 1011. If the high frequency component is smaller than the predetermined value, the flow proceeds to step S202. On the other hand, if the high frequency component is larger than or equal to the predetermined value, the flow proceeds to step S205.

At step S202, the blur corrector 108 determines whether or not a deterioration of the frequency of the blurred image is isotropic. In this case, the high frequency component of the blurred image is smaller than the predetermined value, and accordingly a performance that is expected in a whole of the blurred image is not achieved. Therefore, a defocus (focus shift) by which the frequency in the whole of the blurred image is deteriorated or a hand shake may occur during the photography. In order to determine whether the characteristic of the blur included in the blurred image is the defocus or the hand shake, a direction of the deterioration is determined based on the frequency characteristic of the blurred image. If the deterioration of the frequency is anisotropic, the flow proceeds to step S203. On the other hand, if the deterioration of the frequency is isotropic, the flow proceeds to step S204.

At step S203, the blur corrector 108 sets the characteristic of the blur being estimated to the hand shake. The hand shake indicates a linear PSF (Point Spread Function), and typically it does not have a rotationally symmetric shape. Accordingly, as illustrated in FIG. 8A, the blurred image (hand-shake image) is an image having the anisotropic deterioration of the frequency. When the hand shake occurs, dips (oscillation components in a frequency space) as seen in the frequency characteristic of FIG. 8A occur along a direction corresponding to the hand shake.

At step S204, the blur corrector 108 sets the characteristic of the blur being estimated to the defocus (focus shift). The focus shift indicates a rotationally symmetric PSF. Accordingly, as illustrated in FIG. 8B, the deterioration of the frequency caused by the defocus is an isotropic deterioration that does not depend on a direction.

At step S205, the blur corrector 108 determines whether or not the image capturing condition (focal length and an F number determined during photography) satisfies a predetermined condition. If the focal length is shorter than a predetermined value (predetermined distance) (i.e., wide-angle lens) and the F number is larger than a predetermined value (predetermined F number) (i.e., deep depth), the flow proceeds to step S206. On the other hand, if the focal length is longer than the predetermined value (predetermined distance) or the F number is smaller than the predetermined value (predetermined F number), the flow proceeds to step S207. While both of the focal length and the F number are used in this embodiment, only one of the focal length or the F number may be used to make the determination.

At step S206, the blur corrector 108 sets the characteristic being estimated to the diffraction and the defocus blur. An image captured by using a wide-angle lens to have a deep depth of field may be an image captured for pan-focus (for example, landscape photograph). Accordingly, in this case, the defocus blur is a target to be estimated. Furthermore, since the aperture stop is closed (i.e., the F number is large), the aberration is small but a blur caused by the diffraction may be large. Accordingly, in this case, the diffraction may also be a target to be estimated.

At step S207, the blur corrector 108 sets the characteristic of the blur being estimated to the aberration. In this case, since the aperture stop is not largely closed (i.e., the F number is small), an influence of the diffraction is small and a deterioration caused by the diffraction may be relatively large. Since a high performance is typically required for a telephoto lens having a long focal length, it is necessary to correct the aberration. According to the processing described above, the blur corrector 108 (determiner 1081) is capable of automatically determining the characteristic of the blur being estimated. However, a type of the blur acquired by the processing may be indicated to a user to manually revise it as a manual determination assist (for example, at least one blur which is likely to be selected by the user may be displayed such that the user recognizes it).

Next, a method of determining characteristics of other blurs will be simply described. First, an error aberration can be recognized by detecting a change of an environment such as temperature during the photography, and accordingly it can be determined whether or not the error aberration is to be corrected. The hand shake can be determined based on a relationship between the focal length and the shutter speed. The object motion blur can be determined by diving a blurred image into partial areas and detecting the occurrence of the anisotropic deterioration of the frequency only in specific partial areas. The disturbance tends to occur when a photographing distance and exposure time included in the image capturing condition are long, and accordingly it can be determined based on the photographing distance and the exposure time. As described above, a plurality of images may be synthesized (combined) to correct distortion of an edge caused by the disturbance. Thus, when the blurred image is a synthesized image (combined image) of the plurality of images, it is preferred that the disturbance is to be estimated.

In this embodiment, the blur corrector 108 (generator 1082) changes, depending on the characteristic of the blur, at least one of acquisition processing of the blur estimation area or the estimation processing (blur estimation processing), or a parameter to be used for the acquisition processing or the estimation processing. The blur corrector 108 may further perform denoising processing on the estimated blur. In this case, the blur corrector 18 changes, depending on the characteristic of the blur, at least one of acquisition processing of the blur estimation area, the estimation processing, or the denoising processing, or a parameter to be used for the acquisition processing, the estimation processing, or the denoising processing.

According to this embodiment, an image processing system which is capable of estimating various blurs with high accuracy based on a single image can be provided.

### Embodiment 2

Next, referring to FIG. 9, an image processing system in Embodiment 2 of the present invention will be described. FIG. 9 is a block diagram of an image processing system 300 in this embodiment.

The image processing system 300 of this embodiment is different from the image processing system 100 of Embodiment 1 in that the image processing system 300 includes an image processing apparatus 305 including an estimated blur generator 308 instead of the image processing apparatus 105 including the blur corrector 108. The image processing system 300 of this embodiment is capable of performing a blur estimation by simple processing compared with the image processing system 100 of Embodiment 1. The estimated blur generator 308 estimates and outputs a blur component based on a blurred image captured by the image pickup apparatus 101. Other configurations of the image processing system 300 are the same as those of the image processing system 100 in Embodiment 1, and accordingly descriptions thereof are omitted.

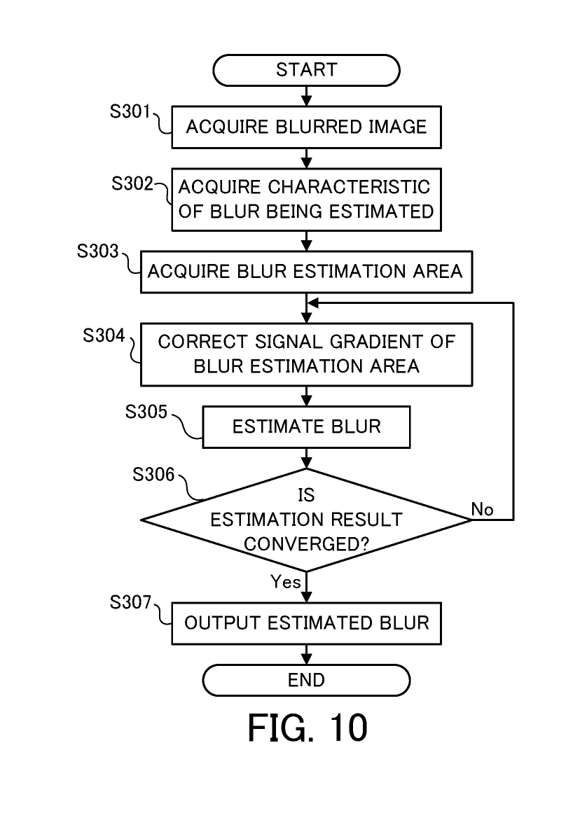

Next, referring to FIG. 10, image processing which is performed by the estimated blur generator 308 will be described. FIG. 10 is a flowchart of illustrating an image processing method in this embodiment. Each step in FIG. 10 is performed by a determiner 3081 (determination unit) and a generator 3082 (generation unit) of the estimated blur generator 308.

Steps S301 and S302 in FIG. 10 are performed by the determiner 3081 of the estimated blur generator 308, and step S303 is performed by the generator 3082 of the estimated blur generator 308. Steps S301 to S303 are the same as steps S101 to S103 in Embodiment 1 described referring to FIG. 1, respectively.

Subsequently, at step S304, the generator 3082 corrects a signal gradient in a blur estimation area acquired at step S303 to generate a blur-corrected signal gradient. A method of correcting the signal gradient is the same as that of step S106 in Embodiment 1 described referring to FIG. 1. Subsequently, at step S305, the generator 3082 estimates a blur based on the signal gradient in the blur estimation area and the blur-corrected signal gradient. A method of estimating the blur is the same as that of step S107 in Embodiment 1 described referring to FIG. 1.

Subsequently, at step S306, the generator 3082 determines whether or not the blur (estimated result) estimated at step S305 is converged. If the blur is converged, the flow proceeds to step S307. On the other hand, if the blur is not converged, the flow returns to step S304. When the flow returns to step S304, the generator 3082 uses the blur estimated at step S305 to newly generate the blur-corrected signal gradient at step S304. Whether the estimated blur is converged can be determined by obtaining a difference or a ratio between a value deteriorated by using a blur used for estimating the blur-corrected signal gradient and the signal gradient in the blur estimation area to compare the difference of the ratio with a predetermined value. Alternatively, if the blur is estimated by an iterative calculation such as a conjugate gradient method at step S305, it may be determined whether or not an update amount of the blur by the iterative calculation is smaller than a predetermined amount.

If the estimation result is converged, at step S307, the generator 308 outputs, as an estimated blur, the blur which has been estimated. The output estimated blur can be used for correcting the blurred image, measuring an optical performance of an optical system used for photography, analyzing a hand shake during the photography, or the like.

According to this embodiment, an image processing system which is capable of estimating various blurs with high accuracy based on a single image can be provided.

### Embodiment 3

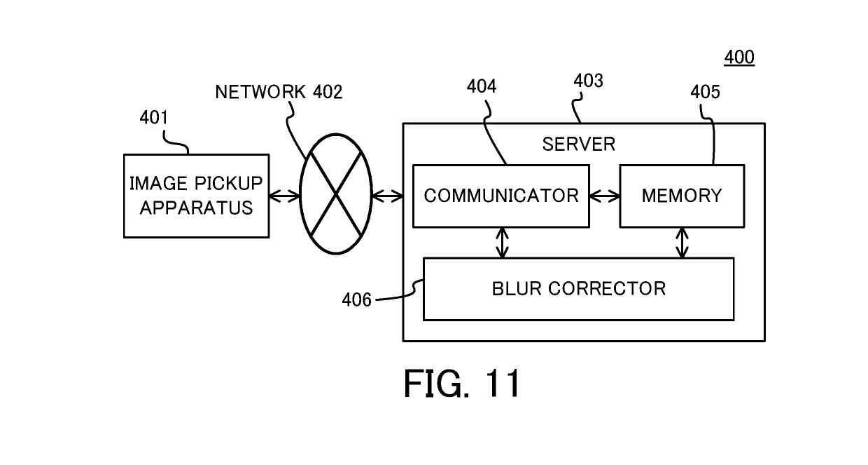

Next, referring to FIG. 11, an image pickup system in Embodiment 3 of the present invention will be described. FIG. 11 is a block diagram of an image pickup system 400 in this embodiment.

The image pickup system 400 includes an image pickup apparatus 401, a network 402, and a server 403 (image processing apparatus). The image pickup apparatus 401 and the server 403 are connected through wire or wirelessly, and an image from the image pickup apparatus 401 is transferred to the server 403 to perform estimation and correction of a blur.

The server 403 includes a communicator 404, a memory 405 and a blur corrector 406 (image processor). The communicator 404 of the server 403 is connected with the image pickup apparatus 401 through the network 402. The image pickup apparatus 401 and the server 403 may be connected by any one of a wired or wireless communication method. The communicator 404 of the server 403 is configured to receive a blurred image from the image pickup apparatus 401. When the image pickup apparatus 401 captures an image, the blurred image (input image or captured image) is input to the server 403 automatically or manually, and it is sent to the memory 405 and the blur corrector 406. The memory 405 stores the blurred image and information relating to an image capturing condition determined when capturing the blurred image. The blur corrector 406 estimates a blur with specific characteristics (estimated blur) based on the blurred image. Then, the blur corrector 406 generates a blur-corrected image based on the estimated blur. The blur-corrected image is stored in the memory 405 or it is sent to the image pickup apparatus 401 through the communicator 404.

In order to achieve the image processing method of this embodiment, software (image processing program) can be supplied to the server 403 through a network or a non-transitory computer-readable storage medium such as a CD-ROM. In this case, the image processing program is read out by a computer (such as a CPU and a MPU) of the server 403 to execute a function of the server 403.

Processing which is performed by the blur correction portion 406 is the same as the image processing method of Embodiment 1 described referring to FIG. 1, and accordingly descriptions thereof are omitted. According to this embodiment, an image pickup system which is capable of estimating various blurs with high accuracy based on a single image can be provided.

As described above, the image processing apparatus (image processing apparatus 105 or 305, or server 403) includes a determiner 1081 or 3081 (determination unit) and a generator 1082 or 3082 (generation unit). The determiner determines a characteristic of a blur to be estimated based on a blurred image (single captured image) (S102 or S302). The generator acquires a blur estimation area of at least a part of the blurred image to generate an estimated blur based on the blur estimation area (S103 to S111, or S303 to S307). The generator repeats (iterates) blur estimation processing (S107 or S305) and correction processing on information relating to a signal in the blur estimation area using the blur (S106 or S304) to generate the estimated blur. The generator changes, depending on the characteristic of the blur, at least one of acquisition processing of the blur estimation area or the blur estimation processing, or a parameter to be used for the acquisition processing or the blur estimation processing (i.e., changes at least one of the processing and the parameter).

In the image processing apparatus, the generator performs denoising processing on the estimated blur (S110). Furthermore, the generator changes, depending on the characteristic of the blur, at least one of acquisition processing of the blur estimation area, the blur estimation processing, or the denoising processing, or a parameter to be used for the acquisition processing, the blur estimation processing, or the denoising processing (i.e., changes at least one of the processing and the parameter).

Preferably, the information relating to the signal in the blur estimation area using the blur is information relating to a luminance distribution in the blur estimation area or a differential value of the luminance distribution (i.e., information relating to a signal gradient). Preferably, the determiner determines the characteristic of the blur based on a frequency characteristic of the blurred image or an image capturing condition for capturing the blurred image (i.e., image capturing condition determined when capturing the blurred image). Preferably, the determiner uses the blurred image to determine the characteristic of the blur automatically or assist a user to determine the characteristic of the blur manually. Preferably, the characteristic of the blur includes at least one of an aberration (designed aberration or error aberration) of an optical system, a diffraction, a defocus (focus shift or defocus blur), a motion blur (hand shake or object motion blur), and a disturbance. Preferably, the generator applies a restriction reflecting the characteristic of the blur when performing the blur estimation processing.

Preferably, the generator reduces a resolution of the blur estimation area to perform the blur estimation processing and the correction processing on the blur estimation area with reduced resolution, and decreases a degree of reduction of the resolution (resolution reduction amount) in the blur estimation area while repeating (iterating) the blur estimation processing and the correction processing.

Preferably, the generator acquires a noise amount included in the blur estimation area, and performs a frequency resolution of the blur estimation area to generate a frequency-resolved blur estimation area. Then, the generator performs a denoising on the frequency-resolved blur estimation area based on the noise amount, and resynthesizes the denoised frequency-resolved blur estimation area (S104). Preferably, the image processing apparatus includes a corrector 1083 (correction unit). The corrector corrects at least a part of the blurred image by using the estimated blur (S112).

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to each embodiment, an image processing apparatus, an image pickup apparatus, an image processing method, and a non-transitory computer-readable storage medium which are capable of estimating various blurs with high accuracy based on a single image can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-121680, filed on Jun. 17, 2015, which is hereby incorporated by reference herein in its entirety.

What is claimed is:

1. An image processing apparatus comprising:
a determiner configured to determine a characteristic of a blur to be estimated based on a blurred image; and
a generator configured to acquire a blur estimation area of at least a part of the blurred image to generate an estimated blur based on the blur estimation area,
wherein the generator is configured to:
repeat blur estimation processing and correction processing on information relating to a signal in the blur estimation area using the blur to generate the estimated blur, and
change, depending on the characteristic of the blur, at least one of acquisition processing of the blur estimation area or the blur estimation processing, or a parameter to be used for the acquisition processing or the blur estimation processing.

2. An image processing apparatus comprising:
a determiner configured to determine a characteristic of a blur to be estimated based on a blurred image; and
a generator configured to acquire a blur estimation area of at least a part of the blurred image to generate an estimated blur based on the blur estimation area,
wherein the generator is configured to:
repeat blur estimation processing and correction processing on information relating to a signal in the blur estimation area using the blur to generate the estimated blur,
perform denoising processing on the estimated blur, and
change, depending on the characteristic of the blur, at least one of acquisition processing of the blur estimation area, the blur estimation processing, or the denoising processing, or a parameter to be used for the acquisition processing, the blur estimation processing, or the denoising processing.

3. The image processing apparatus according to claim 1, wherein the information relating to the signal is information relating to a luminance distribution in the blur estimation area or a differential value of the luminance distribution.

4. The image processing apparatus according to claim 1, wherein the determiner is configured to determine the characteristic of the blur based on a frequency characteristic of the blurred image or an image capturing condition for capturing the blurred image.

5. The image processing apparatus according to claim 1, wherein the determiner is configured to use the blurred image to determine the characteristic of the blur automatically or assist a user to determine the characteristic of the blur manually.

6. The image processing apparatus according to claim 1, wherein the characteristic of the blur includes at least one of an aberration of an optical system, a diffraction, a defocus, a motion blur, and a disturbance.

7. The image processing apparatus according to claim 1, wherein the generator is configured to apply a restriction reflecting the characteristic of the blur when performing the blur estimation processing.

8. The image processing apparatus according to claim 1, wherein the generator is configured to:
reduce a resolution of the blur estimation area to perform the blur estimation processing and the correction processing on the blur estimation area with reduced resolution, and
decrease a degree of reduction of the resolution in the blur estimation area while repeating the blur estimation processing and the correction processing.

9. The image processing apparatus according to claim 1, wherein the generator is configured to:
acquire a noise amount included in the blur estimation area,
perform a frequency resolution of the blur estimation area to generate a frequency-resolved blur estimation area,
perform a denoising on the frequency-resolved blur estimation area based on the noise amount, and
resynthesize the denoised frequency-resolved blur estimation area.

10. The image processing apparatus according to claim 1, further comprising a corrector configured to correct at least a part of the blurred image by using the estimated blur.

11. An image pickup apparatus comprising:
an image pickup element configured to photoelectrically convert an optical image formed via an optical system to output an image signal;
a determiner configured to determine a characteristic of a blur to be estimated based on a blurred image generated based on the image signal; and
a generator configured to acquire a blur estimation area of at least a part of the blurred image to generate an estimated blur based on the blur estimation area,
wherein the generator is configured to:
repeat blur estimation processing and correction processing on information relating to a signal in the blur estimation area using the blur to generate the estimated blur, and
change, depending on the characteristic of the blur, at least one of acquisition processing of the blur estimation area or the blur estimation processing, or a parameter to be used for the acquisition processing or the blur estimation processing.

12. An image pickup apparatus comprising:
an image pickup element configured to photoelectrically convert an optical image formed via an optical system to output an image signal;
a determiner configured to determine a characteristic of a blur to be estimated based on a blurred image generated based on the image signal; and
a generator configured to acquire a blur estimation area of at least a part of the blurred image to generate an estimated blur based on the blur estimation area,
wherein the generator is configured to:
repeat blur estimation processing and correction processing on information relating to a signal in the blur estimation area using the blur to generate the estimated blur,
perform denoising processing on the estimated blur, and
change, depending on the characteristic of the blur, at least one of acquisition processing of the blur estimation area, the blur estimation processing, or the denoising processing, or a parameter to be used for the acquisition processing, the blur estimation processing, or the denoising processing.

13. An image processing method comprising the steps of:
determining a characteristic of a blur to be estimated based on a blurred image; and
acquiring a blur estimation area of at least a part of the blurred image to generate an estimated blur based on the blur estimation area,
wherein the step of generating the estimated blur includes:
repeating blur estimation processing and correction processing on information relating to a signal in the blur estimation area using the blur to generate the estimated blur, and
changing, depending on the characteristic of the blur, at least one of acquisition processing of the blur estimation area or the blur estimation processing, or a parameter to be used for the acquisition processing or the blur estimation processing.

14. An image processing method comprising the steps of:
determining a characteristic of a blur to be estimated based on a blurred image; and
acquiring a blur estimation area of at least a part of the blurred image to generate an estimated blur based on the blur estimation area,
wherein the step of generating the estimated blur includes:
repeating blur estimation processing and correction processing on information relating to a signal in the blur estimation area using the blur to generate the estimated blur,
performing denoising processing on the estimated blur, and
changing, depending on the characteristic of the blur, at least one of acquisition processing of the blur estimation area, the blur estimation processing, or the denoising processing, or a parameter to be used for the acquisition processing, the blur estimation processing, or the denoising processing.

15. A non-transitory computer-readable storage medium storing an image processing program which causes a computer to execute a process comprising the steps of:
determining a characteristic of a blur to be estimated based on a blurred image; and
acquiring a blur estimation area of at least a part of the blurred image to generate an estimated blur based on the blur estimation area,
wherein the step of generating the estimated blur includes:
repeating blur estimation processing and correction processing on information relating to a signal in the blur estimation area using the blur to generate the estimated blur, and
changing, depending on the characteristic of the blur, at least one of acquisition processing of the blur estimation area or the blur estimation processing, or a parameter to be used for the acquisition processing or the blur estimation processing.

16. A non-transitory computer-readable storage medium storing an image processing program which causes a computer to execute a process comprising the steps of:
determining a characteristic of a blur to be estimated based on a blurred image; and
acquiring a blur estimation area of at least a part of the blurred image to generate an estimated blur based on the blur estimation area,
wherein the step of generating the estimated blur includes:
repeating blur estimation processing and correction processing on information relating to a signal in the blur estimation area using the blur to generate the estimated blur,
performing denoising processing on the estimated blur, and
changing, depending on the characteristic of the blur, at least one of acquisition processing of the blur estimation area, the blur estimation processing, or the denoising processing, or a parameter to be used for the acquisition processing, the blur estimation processing, or the denoising processing.
